(19) United States
(12) Patent Application Publication
(10) Pub. No.: US 2007/0122593 A1
(43) Pub. Date: May 31, 2007

(54) Wallboard tape

(76) Inventor: John S. Conboy, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/271,623

(22) Filed: Nov. 12, 2005

(51) Int. Cl. B32B 3/30

(52) U.S. Cl. 428/167; 428/192

(57) ABSTRACT

A wallboard tape including a paper tape having two outer edges. At least one pair of raised beads are adhered to the tape and extend parallel to the outer edges of the tape. The beads may optionally be formed on the tape from a hot melt adhesive and optionally have a generally arcuate top surface. At least one polyvinyl chloride stiffening strip may optionally be adhered to the tape with a hot melt adhesive and a protuberance on the side of the tape opposite the beads and running the length of the tape near the center of the tape also may optionally be applied.

### FIELD OF THE INVENTION

This invention relates to wallboard tape. More particularly the present invention relates to wallboard tape wallboard compound adherence beads.

### BACKGROUND OF THE INVENTION

Paper wallboard tape tends to absorb water and soften when applied over thick amounts of compound as is necessary when taping irregular joints and corners. When the paper tape softens, it sags and deforms and a straight line corner is not achieved. Thus, paper tape must be applied over thin layers of compound which requires a number of coats of compound or the imperfections must be pre-filled, increasing labor costs and time to finish. Paper tape does, however, provide good adherence to the compound and provides a good paint surface.

Wallboard tape made from polyvinyl chloride (“PVC”) is known. While PVC tape provides very straight and durable corner beads and seam joints for wallboard installations, the challenge with PVC is to get a strong adherence of the wallboard compound to the PVC tape.

One such product, by the inventor of the present invention, is shown in U.S. Pat. No. 5,418,027, issued to John S. Conboy (the '027 patent), the contents of which are incorporated herein by reference. In the '027 patent, a plastic wallboard tape has a raised center section and outwardly extending wing areas having a coating of fibers adhered to both sides. The raised center of the tape is weakened at the top to cause the tape to crease in a straight line when it is folded at an inside or outside corner to define a straight edge at the corner joint. The combination of the rigid water impervious tape and the fibers allows the tape to be applied over imperfectly fitted wallboard joints with large imperfections because the fibers will achieve a mechanical bond with the wallboard compound or other joint materials, allowing a slow cure, and the tape will not be softened by the compound.

While the invention of the '027 patent greatly improves the adherence of wallboard compound to PVC tape, there is still a need to achieve better adherence of the compound to PVC tape and better acceptance of paint. The present invention achieves this goal.

### SUMMARY OF THE INVENTION

A wallboard tape comprising a paper tape having two outer parallel edges. At least one pair of raised beads are adhered to the tape and extend generally parallel to the outer edges of the tape. The beads may optionally be formed on the tape from a hot melt adhesive and optionally have a generally arcuate top surface. At least one polyvinyl chloride stiffening strip may optionally be adhered to the tape with a hot melt adhesive and a protuberance on the side of the tape opposite the beads and running the length of the tape near the center of the tape also may optionally be applied.

### DESCRIPTION OF THE DRAWINGS

In the accompanying drawings which form part of the specification and wherein like numbers and letters refer to like parts wherever they occur

FIG. 1 is a fragmentary plan view of a length of wallboard tape according to an embodiment of the present invention;

FIG. 2 is an end view of a length of wallboard tape according to an embodiment of the present invention;

FIG. 3 is an enlarged partial end view of a length of wallboard tape according to an embodiment of the present invention;

FIG. 4 is another enlarged partial end view of a length of wallboard tape according to an embodiment of the present invention;

FIG. 5 is a fragmentary plan view of a length of wallboard tape according to a second and third embodiment of the present invention;

FIG. 6 is an end view of a length of wallboard tape according to a second and third embodiment of the present invention;

FIG. 7 is an enlarged partial end view of a length of wallboard tape according to a second and third embodiment of the present invention;

FIG. 8 is another enlarged partial end view of a length of wallboard tape according to a second and third embodiment of the present invention;

FIG. 9 is an end view of a length of wallboard tape applied to a wallboard seam according to a second and third embodiment of the present invention. For clarity, wallboard compound has been omitted from this view;

FIG. 10 is an end view of a length of wallboard tape according to a variation of the first embodiment of the present invention; and

FIG. 11 is another enlarged partial vertical sectional view taken along line B-B of FIG. 10 of a length of wallboard tape according to an embodiment of the present invention.

### DETAILED DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. The scope of the present invention is intended to be limited only by the explicit terms of the claims.

The present invention comprises an improvement in composite paper-based wallboard tape. Specifically, in the preferred embodiment of the invention, the tape comprises one or more raised beads adhered to the tape and, preferably, run adjacent the outer edges of the tape to improve tape adherence to the wallboard compound. The tape may further include one or more PVC strips that are preferably located along the length of the tape and between the raised beads. The beads may be continuous or interrupted.

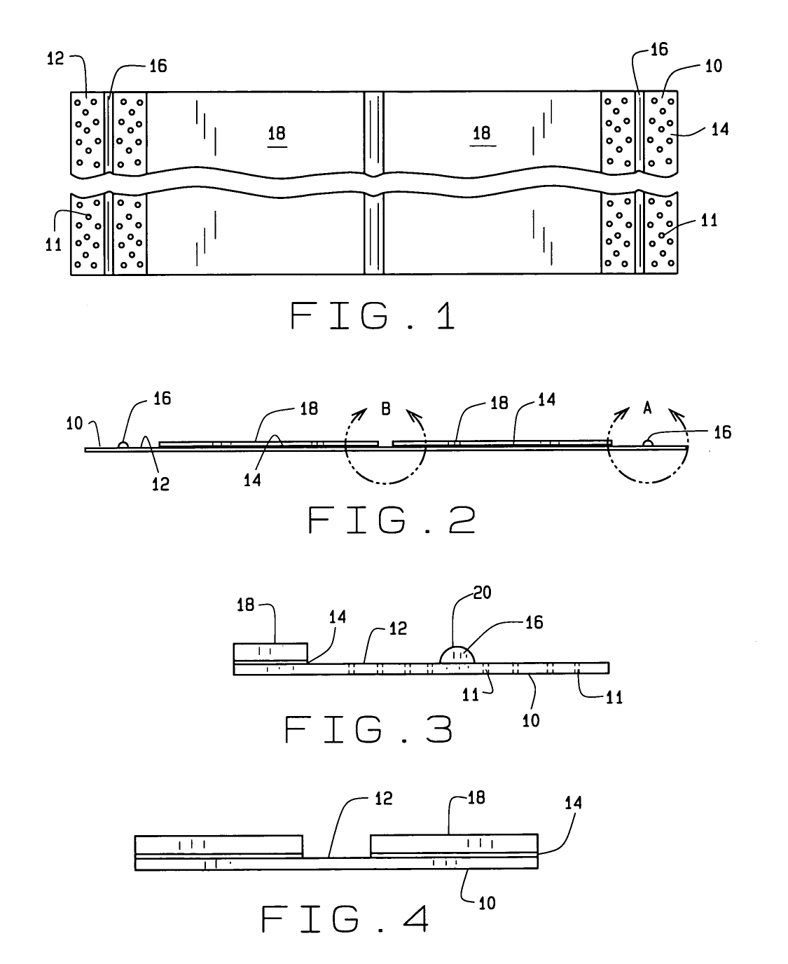

In that regard and referring to FIGS. 1 and 2, a first embodiment of the present invention is shown. The first embodiment comprises a standard paper-based wallboard tape 10. The tape 10 preferably defines a plurality of punctures 11 for allowing joint compound to more quickly dry. Adhered to a top surface 12 of the tape 10 is a skim coat or tapered coat of an adhesive 14, preferably a hot melt material. The hot melt material is preferably a polyamide hot melt material. Furthermore when the adhesive 14 is applied, two raised beads 16 of adhesive are formed, as shown in FIG. 3. Although the beads 16 are preferably formed by the adhesive 14, it is within the scope of the present invention to apply a separately formed bead 16 to the tape 10 by using the adhesive 14. Also applied to the adhesive are two stiffening strips 18. The stiffening strips 18 are preferably made from polyvinyl chloride (PVC) and provide a rigid, straight surface, so that tape 10 will provide a flat, straight seam whether the tape 10 is covering a flat seam of two adjacent pieces of wallboard or is folded to form an inside or outside corner bead where two pieces of wallboard meet at an angle.

The tape 10 is preferably about 2 inches wide and about 0.009 inches thick and the stiffening strips 18 are preferable about 0.719 inches wide each and about 0.016 inches thick and separated by about 0.063 inches. Moreover, the raised beads are preferably about 0.015 in height above the skim coat of adhesive which is about 0.002 in thickness. The raised beads 16 generally form an arcuate top surface 20.

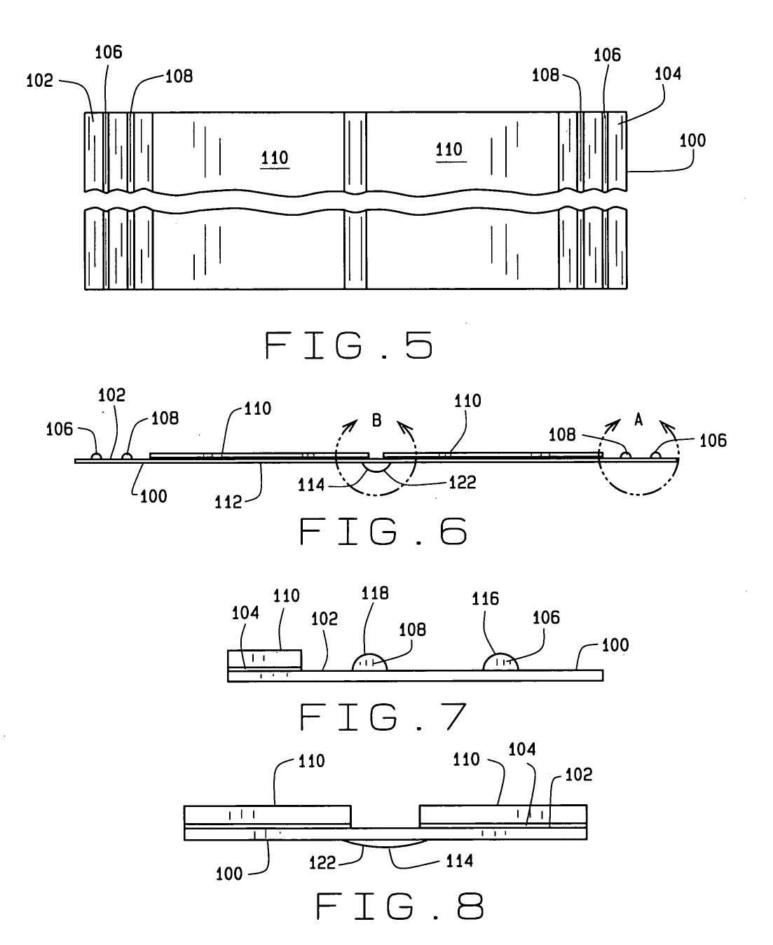

Referring to another embodiment of the present invention in FIGS. 5-8, adhered to a top surface 102 of a paper-based wallboard tape 100 is a skim coat or tapered coat of an adhesive 104, also preferably a hot melt material and more preferably a polyamide hot melt material. Furthermore, when the adhesive 104 is applied, four raised beads 106 and 108 of adhesive are formed, as shown in FIG. 5. Although the beads 106 and 108 are preferably formed by the adhesive, it is within the scope of the present invention to apply a separately formed bead to the tape 100 by using the adhesive. Also applied to the adhesive are two stiffening strips 110. The stiffening strips 110 are preferably made from polyvinyl chloride and provide a rigid, straight surface, so that tape will provide a flat, straight seam whether the tape covers a flat seam of two adjacent pieces of wallboard or is folded to form an inside or outside corner bead where two pieces of wallboard meet at an angle. Also provided on an underside 112 of the tape 100 is a protuberance 114, preferably formed from a polyamide hot melt material.

The tape 100, in one embodiment, is preferably about 3 inches wide and about 0.009 inches thick, and the stiffening strips 18 are preferable about 1.063 inches wide and about 0.025 inches thick each and separated by about 0.125 inches. The raised beads 106 are preferably about 0.015 inches in height above the skim coat or tapered coat of adhesive, which is about 0.002 inches in thickness, and the beads are about 0.030 inches wide. Moreover, the raised beads 108 are preferably about 0.020 inches in height above the skim coat or tapered coat of adhesive and about 0.040 inches wide. The raised beads 106 and 108 generally form arcuate top surfaces 116 and 118. The protuberance 114 is preferably about 0.125 inches wide and about 0.006 inches tall and has a top surface 122 that forms an arcuate surface. The arcuate surface preferably has a radius of about 0.329 inches.

The tape 100, in another embodiment, is preferably about 4.125 inches wide and about 0.009 inches thick, and the stiffening strips 18 are preferable about 1.500 inches wide and about 0.030 inches thick each and separated by about 0.125 inches. The raised beads 106 are preferably about 0.015 inches in height above the skim coat or tapered coat of adhesive, which is about 0.002 inches in thickness, and the beads 106 are about 0.030 inches in width. Moreover, the raised beads 108 are preferably about 0.024 inches in height above the skim coat or tapered coat of adhesive and about 0.048 inches in width. The raised beads 106 and 108 generally form arcuate top surfaces 116 and 118. The protuberance 114 is preferably about 0.125 inches wide and about 0.006 inches tall and has a top surface 122 that forms an arcuate surface. The arcuate surface preferably has an about 0.329 inch radius.

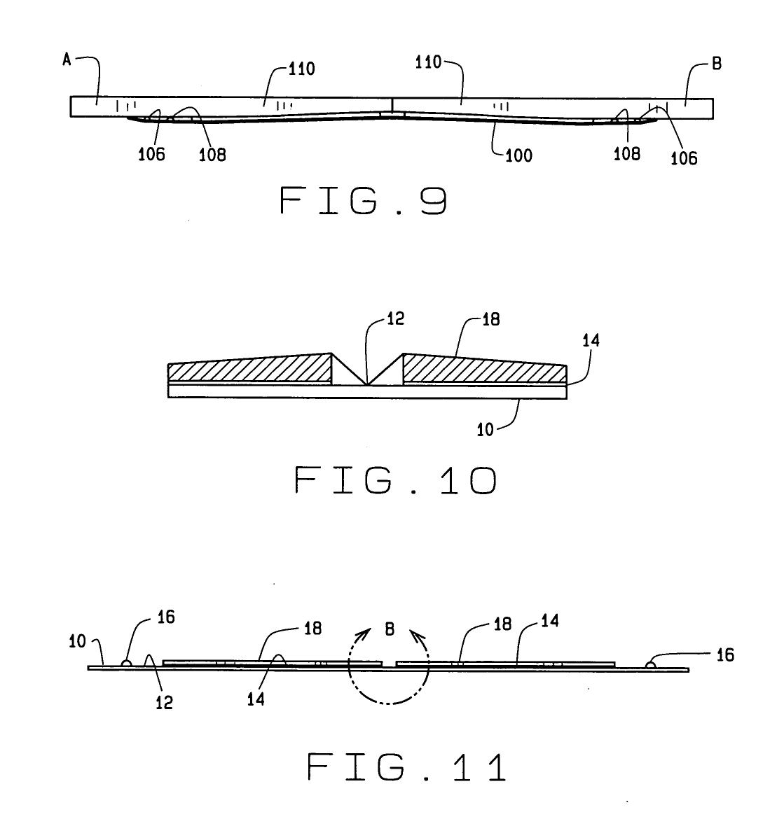

Referring to FIG. 9, the wallboard tape 100 according to the present invention is applied to wallboard A and B by first providing a layer of wallboard compound to the wallboard seam to be taped. Next, the wallboard tape is applied to the wallboard compound with the beads 106 and 108 facing the wallboard and the applied wallboard compound. The tape 100 is then embedded into the wallboard compound with a trowel, which forces the beads 106 and 108 into the compound for firm adhesion of the tape 100 to the wallboard and wallboard compound. A top layer of wallboard compound is applied to the tape which is sanded to finish. Further layers of wallboard compound may be added and sanded to provide an appropriate finish. The tape 10 is similarly applied.

Referring to FIGS. 10 and 11, in a variation of the first embodiment, the adhesive may be applied on about a 0.002 inch to 0.010 inch taper below the stiffening strip to provide it on a taper. This is to accommodate drywall tapers who prefer such a taper to assist them in applying drywall compound. Also provided is a tapered bead between the stiffening strips 18 of hot melt material. In this embodiment, the distance between the stiffening strips 18 is preferably twice the thickness of the stiffening strips 18.

While the specific embodiments have been illustrated and described, numerous modifications come to mind without significantly departing from the spirit of the invention, and the scope of protection is only limited by the scope of the accompanying claims.

What is claimed is:

1. A wallboard tape comprising:
a paper tape having two outer edges; and
one or more raised beads adhered to the tape and extending parallel to the outer edges of the tape.

2. The wallboard tape of claim 1 wherein the one or more raised beads comprise an inner pair of parallel beads and an outer pair of parallel beads.

3. The wallboard tape of claim 2 wherein the inner pair of parallel beads are larger than the outer pair of parallel beads.

4. The wallboard tape of claim 1 further comprising at least one stiffening strip applied to the tape.

5. The wallboard tape of claim 1 having a tapered coating of hot melt glue applied to adhere one or more stiffening strips.

6. The wallboard tape of claim 4 wherein the stiffening strip is polyvinyl chloride.

7. The wallboard tape of claim 4 wherein the stiffening strip is adhered with a polyamide hot melt material.

8. The wallboard tape of claim 1 wherein the one or more beads are made from a polyamide hot melt material.

9. The wallboard tape of claim 1 wherein the one or more beads have an arcuate top surface.

10. The wallboard tape of claim 1 further comprising a protuberance on the side of the tape opposite the one or more beads that runs substantially the length of the tape and generally near the center of the tape.

11. The wallboard tape of claim 10 wherein the protuberance comprises a polyamide hot melt material.

12. A wallboard tape comprising:
a paper tape having two outer edges;
at least one pair of raised beads adhered to the tape and extending parallel to the outer edges of the tape; and
at least one stiffening strip applied to the tape.

13. The wallboard tape of claim 12 wherein the at least one pair of raised beads comprise an inner pair of parallel beads and an outer pair of parallel beads.

14. The wallboard tape of claim 13 wherein the inner pair of parallel beads are larger than the outer pair of parallel beads.

15. The wallboard tape of claim 12 wherein the stiffening strip is polyvinyl chloride.

16. The wallboard tape of claim 12 wherein the at least one pair of parallel beads are made from a polyamide hot melt material.

17. The wallboard tape of claim 12 wherein the at least one pair of parallel beads each have an arcuate top surface.

18. The wallboard tape of claim 12 further comprising a protuberance on the side of the tape opposite the one or more beads that runs substantially the length of the tape and generally near the center of the tape.

19. The wallboard tape of claim 18 wherein the protuberance comprises a polyamide hot melt material.

20. A wallboard tape comprising:
a paper tape having two outer parallel edges;
at least one pair of raised beads adhered to the tape and extending adjacent and parallel to the outer edges of the tape, the beads being formed on the tape from a hot melt adhesive and having a generally arcuate top surface; and
at least one polyvinyl chloride stiffening strip adhered to the tape with a hot melt adhesive.

21. The wallboard tape of claim 20 further comprising a protuberance on the side of the tape opposite the at least one pair of beads that runs substantially the length of the tape and generally near the center of the tape.
